(19) United States
(12) Patent Application Publication
(10) Pub. No.: US 2011/0057606 A1
(43) Pub. Date: Mar. 10, 2011

(54) SAFETY FEATURE FOR WIRELESS CHARGER

(75) Inventor: Esa Ilmari SAUNAMÄKI, Virrat (FI)

(73) Assignee: NOKIA CORPATION, Espoo (FI)

(21) Appl. No.: 12/554,468

(22) Filed: Sep. 4, 2009

(51) Int. Cl. H02J 7/00

(52) U.S. Cl. 320/108

(57) ABSTRACT

Example embodiments are disclosed for detecting the proximity of a user to a wireless charger and switching off or gradually reducing the power applied to the transmitting coils as long as the user is closer than a threshold distance. In embodiments, a power source circuit in a wireless charging device is configured to produce a source alternating current. A transmitting coil is configured to magnetically couple with a proximately located receiving coil in a user's device, using contact-less electromagnetic induction, to wirelessly provide power to the receiving coil. A power control circuit is coupled between the power source and the transmitting coil, having a control input configured to control power delivered from the power source to the transmitting coil. A proximity detector is positioned near the transmitting coil and coupled to the control input of the power control circuit, to detect proximity of the user to the detector and provide a control signal to the power control circuit to cause the power control circuit to reduce power delivered from the power source to the transmitting coil. In this manner, the exposure of the user is minimized near the active charging surface, to the intense electromagnetic fields required in wireless chargers.

### FIELD

The technical field relates to wireless charging of batteries in portable devices. More particularly, the technical field relates to techniques for reducing exposure to users of the electromagnetic charging fields used in wireless chargers.

### BACKGROUND

Rechargeable batteries in cellular phones and other portable communication devices, such as NiCd, nickel-metal hydride (NiMH), Lithium-ion, and Lithium-Polymer batteries and Super Capacitors, can be recharged with household alternating current (AC) power coupled through a voltage reduction transformer, an alternating-to-direct current converter, and appropriate battery monitoring and charging circuits. They can also be recharged with a 12-volt cigarette lighter socket provided in an automobile coupled through a DC voltage reduction circuit and appropriate battery monitoring and charging circuits. However, in both cases, the portable communication device must be plugged into the household AC power source or into the automobile power source, limiting the mobility of the communication device.

Recently, wireless charging has become available for rechargeable batteries in cellular phones and other portable communication devices, using contact-less electromagnetic induction. A power source circuit in a wireless charging device drives a resonant frequency circuit that produces a source alternating current in a frequency range for example between 50 kHz and 20 MHz, which is driven through a transmitting coil in the charging device. The alternating magnetic field produced by the transmitting coil inductively couples with a corresponding receiving coil in the cellular phone or other portable communication device, thereby producing a corresponding induced alternating current that drives a circuit at its resonant frequency in the range for example between 50 kHz and 20 MHz to produce an output AC voltage. A conversion circuit in the cellular phone or other portable communication device, uses a transformer to adjust the output AC voltage, an alternating-to-direct current converter, and appropriate battery monitoring and charging circuits to produce an appropriate DC charging voltage for the rechargeable battery.

Large sized wireless charging pads have become available to charge rechargeable batteries in multiple portable communication devices, high powered hand tools, domestic appliances, or garden tools using contact-less electromagnetic induction. Wireless charging pads are generally shaped as a flat plate and typically have an active charging surface approximately the size of a sheet of typing paper. Other shapes for the charging pad may not be flat, but instead shaped to conform to particularly shaped user devices to be charged, for example a charger shaped as a wall-mounted holder for a garden tool. Wireless charging pads use multiple transmitting coils or a single large transmitting coil to distribute their magnetic flux over the active charging surface. Higher power levels greater than one watt may be required to drive the transmitting coils in a wireless charging pad in order to provide sufficient power to charge rechargeable batteries in multiple portable communication devices or other hand tools or appliances. This may be a cause for concern for the safety of users nearby.

The International Commission on Non-Ionizing Radiation Protection (ICNIRP) has published guidelines for limiting exposure to electromagnetic fields, in an article entitled “Limiting Exposure to Time-Varying Electric, Magnetic, and Electromagnetic Fields (up to 300 GHz)”, Health Physics 74 (4): 494-522; 1998. The high power levels required in wireless charging pads may produce electromagnetic fields whose intensity near to the active charging surface may exceed the ICNIRP guidelines.

### SUMMARY

Example embodiments are disclosed for detecting the proximity of a user to a wireless charger and switching off or gradually reducing the power applied to the transmitting coils as long as the user is closer than a threshold distance. In embodiments, a power source circuit in a wireless charging device is configured to produce a source alternating current. A transmitting coil is configured to magnetically couple with a proximately located receiving coil in a user's device, using contact-less electromagnetic induction, to wirelessly provide power to the receiving coil. A power control circuit is coupled between the power source and the transmitting coil, having a control input configured to control power delivered from the power source to the transmitting coil. The controlled power can be a simple binary on/off control or it may be a graduated step-wise control, or it may be a continuous control between a minimum and maximum output power. A proximity detector is positioned near the transmitting coil and coupled to the control input of the power control circuit, to detect proximity of the user to the detector and provide a control signal to the power control circuit to cause the power control circuit to reduce power delivered from the power source to the transmitting coil. Power control circuit may optionally be integrated with circuits of the power source. In this manner, the exposure of the user is minimized to the intense electromagnetic fields required in wireless chargers.

In example embodiments, the transmitting coil in the charger may be part of a self-resonant circuit and the receiving coil in the user's device may be part of a self-resonant circuit and each self-resonant circuit may be tuned to resonate at the same frequency so as to operate as magnetically coupled resonators. The transmitting coil and the receiving coil are then strongly coupled when the power source circuit in the charging device drives the transmitting coil at the resonant frequency common to both coils, even when the distance between the two coils is several times larger than the geometric sizes of the coils. This resonant magnetic coupling enables efficient power transfer from the wireless charger to the wirelessly charged device.

In example embodiments, the proximity detector may be an infrared body heat detector configured to detect a threshold level of infrared body heat radiating from the user and to cause the power control circuit to reduce power delivered from the power source to the transmitting coil. In embodiments, the proximity detector may be an infrared pulse detector configured to transmit a primary infrared pulse signal and to detect a threshold level of reflected infrared pulse signal from the user and to cause the power control circuit to reduce power delivered from the power source to the transmitting coil. The proximity detector may be an ultrasonic detector configured to transmit a primary ultrasound signal and to detect a threshold level of reflected ultrasound signal from the user and to cause the power control circuit to reduce power delivered from the power source to the transmitting coil. The proximity detector may be an optical detector configured to transmit a primary light signal and to detect a threshold level of reflected light signal from the user and to cause the power control circuit to reduce power delivered from the power source to the transmitting coil. The proximity detector may be an acoustic detector configured to transmit a primary acoustic signal and to detect a threshold level of reflected acoustic signal from the user and to cause the power control circuit to reduce power delivered from the power source to the transmitting coil. The proximity detector may be a microwave detector configured to transmit a primary microwave signal and to detect a threshold level of reflected microwave signal from the user and to cause the power control circuit to reduce power delivered from the power source to the transmitting coil. The proximity detector may be a combination of two or more detectors taken from the group consisting of an infrared detector, an ultrasonic detector, an optical detector, an acoustic detector, and a microwave detector, the combination of detectors configured to detect proximity of the user and to cause the power control circuit to reduce power delivered from the power source to the transmitting coil.

In embodiments, the detector and the transmitting coil may be configured to be positioned in close proximity to one another on a substrate generally shaped as a flat plate.

In embodiments, the power control circuit may reduce power to the transmitting coil upon receiving the control signal from the detector, so as to reduce ambient electromagnetic fields near the transmitting coil below a safe exposure level for the user.

In embodiments, the transmitting coil being configured to wirelessly charge rechargeable batteries in multiple portable communication devices, high powered hand tools, domestic appliances, or garden tools using contact-less electromagnetic induction.

In embodiments, a method includes the steps of generating an alternating current in a wireless charger; driving a transmitting coil with the alternating current to produce an electromagnetic field; magnetically coupling a proximately located receiving coil in a user's device with the electromagnetic field to wirelessly provide power to the receiving coil; detecting proximity of a user to the transmitting coil; and reducing the alternating current to the transmitting coil in response to detecting the proximity of the user, to reduce exposure of the user to the electromagnetic field. In this manner, the exposure of the user is minimized to the intense electromagnetic fields required in wireless chargers.

### DESCRIPTION OF THE FIGURES

FIG. 1A illustrates an example embodiment for a wireless charger.

FIG. 1B illustrates another example embodiment for a wireless charger.

FIG. 2A illustrates an example embodiment for a wirelessly charged user device, such as a portable communication device.

FIG. 2B illustrates an example embodiment wherein the transmitting coil in the charger may be part of a resonant circuit and the receiving coil in the user's device may be part of a resonant circuit and each resonant circuit may be tuned to resonate at the same frequency “F” so as to operate as magnetically coupled resonators.

FIG. 3A illustrates an example embodiment for a wireless charger with the power transmitting coil being a printed wiring coil on a printed wiring board and the proximity detector mounted on the board.

FIG. 3B illustrates an example embodiment for the wireless charger with the power transmitting coil being a printed wiring coil on a printed wiring board and the wirelessly charged user device with the power receiving coil being a printed wiring coil on a printed wiring board.

FIG. 3C illustrates a side-view of a single turn of the power transmitting coil and the resulting pattern of magnetic flux encircling the single turn of the coil.

FIG. 4A illustrates an example of the infrared pulse proximity detector providing a control signal to the power control circuit to cause the power control circuit to reduce power delivered from the power source to the transmitting coil.

FIG. 4B illustrates an example of the ultrasonic proximity detector providing a control signal to the power control circuit to cause the power control circuit to reduce power delivered from the power source to the transmitting coil.

FIG. 4C illustrates an example of the optical proximity detector providing a control signal to the power control circuit to cause the power control circuit to reduce power delivered from the power source to the transmitting coil.

FIG. 4D illustrates an example of the acoustic proximity detector providing a control signal to the power control circuit to cause the power control circuit to reduce power delivered from the power source to the transmitting coil.

FIG. 4E illustrates an example of the microwave proximity detector providing a control signal to the power control circuit to cause the power control circuit to reduce power delivered from the power source to the transmitting coil.

FIG. 4F illustrates an example of the proximity detector being a combination of an infrared detector, an ultrasonic detector, an optical detector, an acoustic detector, and a microwave detector, the combination of detectors configured to detect proximity of the user and to cause the power control circuit to reduce power delivered from the power source to the transmitting coil.

FIG. 5 is an example set of graphs in the time domain, illustrating the relationship of the measured proximity distance from the proximity detector using a time of flight measurement to the user and the resulting power output from the power control circuit to the transmitting coil.

FIG. 6 illustrates an example of the infrared body heat proximity detector providing a control signal to the power control circuit to cause the power control circuit to reduce power delivered from the power source to the transmitting coil.

FIG. 7 is an example set of graphs in the time domain, illustrating the relationship of the measured proximity distance from the proximity detector using infrared user's body heat proximity detector of FIG. 6A and the resulting power output from the power control circuit to the transmitting coil.

FIG. 8 illustrates an example of the proximity detector being a combination of the infrared user's body heat proximity detector of FIG. 6A, an ultrasonic detector, an optical detector, an acoustic detector, and a microwave detector, the combination of detectors configured to detect proximity of the user and to cause the power control circuit to reduce power delivered from the power source to the transmitting coil.

FIG. 9 is an example flow diagram of an example operation for a wireless charger.

### DISCUSSION OF EXAMPLE EMBODIMENTS OF THE INVENTION

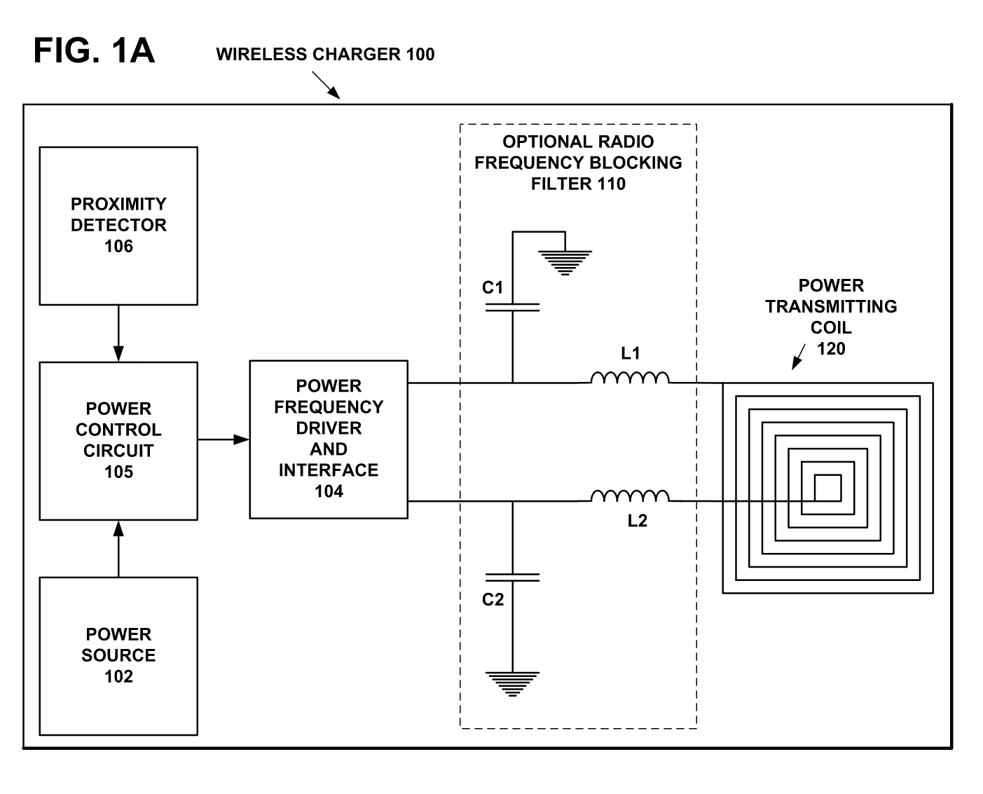

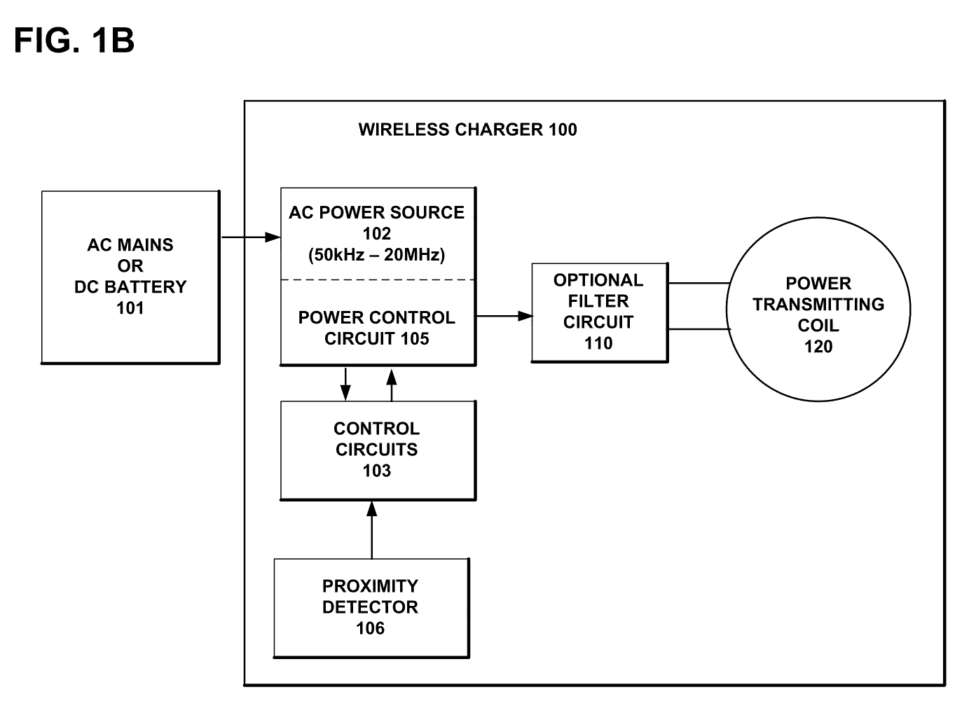

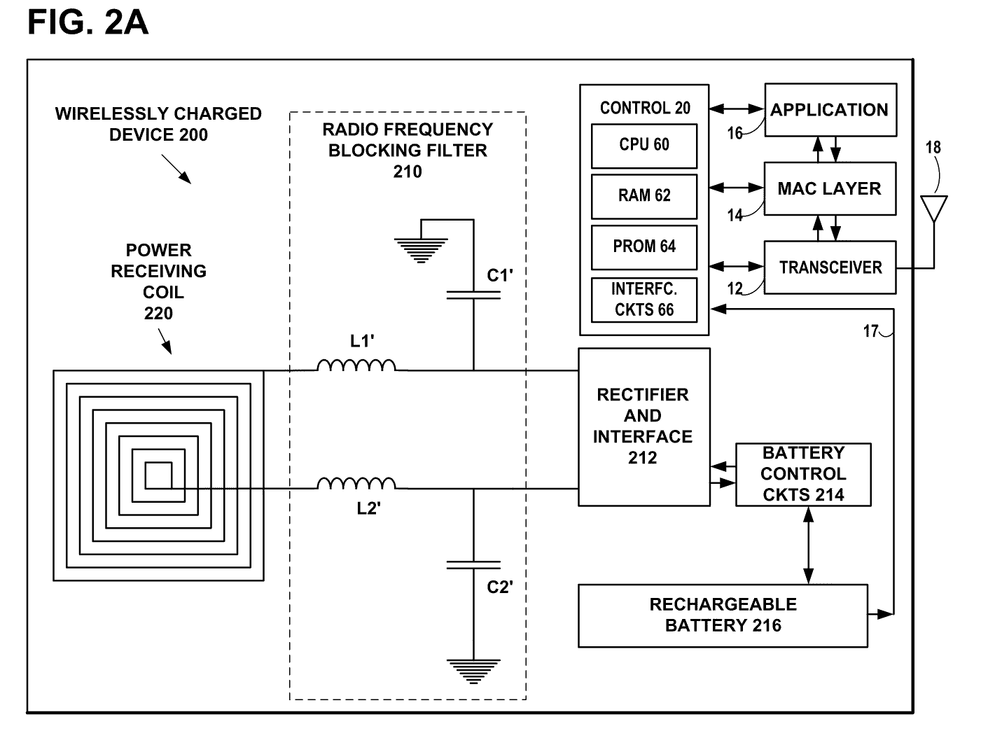

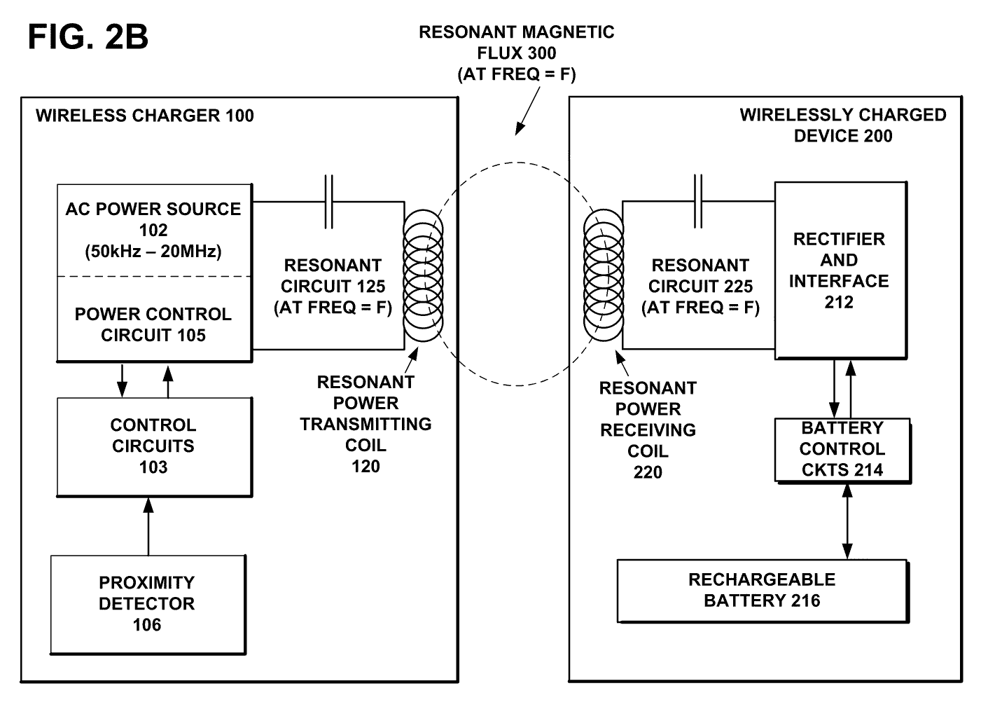

FIG. 1A illustrates an example embodiment for a wireless charger 100, also known as a wireless charging pad 100. The wireless charger 100 includes a proximity detector 106 that detects the proximity of a user to the wireless charger 100 and switches off or gradually reduces the power applied to the transmitting coils 120 as long as the user is closer than a threshold distance. In embodiments, a power source circuit 102 in the wireless charger 100 is configured to produce a source alternating current, for example in a frequency range for example between 50 kHz and 20 MHz. A transmitting coil 120 is configured to magnetically couple with a proximately located receiving coil 220 in a user's device 200 of FIG. 2, using contact-less electromagnetic induction, to wirelessly provide power to the receiving coil 220. A power control circuit 105 is coupled between the power source 102 and the transmitting coil 120, having a control input configured to control power delivered from the power source 102 to the transmitting coil 120. The controlled power can be a simple binary on/off control or it may be a graduated step-wise control, or it may be a continuous control between a minimum and maximum output power. The proximity detector 106 is positioned near the transmitting coil 120 and coupled to the control input of the power control circuit 105, to detect proximity of the user to the detector 106 and provide a control signal to the power control circuit 105 to cause the power control circuit to reduce power delivered from the power source 102 to the transmitting coil 120. In this manner, the exposure of the user is minimized near the active charging surface of the wireless charger 100, to the intense electromagnetic fields. The detector(s) can also detect the proximity of pets or domestic animals, in addition to a human user.

In an example embodiment, a power source circuit 102 in the wireless charging device 100 drives a power frequency driver and interface 104 through the power control circuit 105, which produces a source alternating current in a frequency range, for example, between 50 kHz and 20 MHz, which will provide energy to recharge the rechargeable batteries 216 in the user's charged device 200 of FIG. 2.

The controlled power can be a simple binary on/off control or it may be a graduated step-wise control, or it may be a continuous control between a minimum and maximum output power. FIG. 1B illustrates another example embodiment for a wireless charger, wherein an AC mains or DC battery 101 provides power to the AC power source 102 to output alternating current in a range, for example, from 50 kHz to 20 MHz. Control circuits 103 monitor the output from the AC mains or DC battery 101 and the control signals from the proximity detector 105 to control the level of power output by the power source 102 through the power control circuit 105 to the power transmitting coil 120. For example, the graduated power steps output by the power source 102 through the power control circuits 105 to the power transmitting coil 120, may be controlled by the control circuits 103 based on the distance measured by the proximity detector 105 between the user and the transmitting coil 120. For example, for a relative Max power=5, and a low power=1, the controlled graduations in power vs. proximity (in centimeters) may be:
User touch to device or distance 10 cm->Power off or smallest power step 1
User to charger distance 20 cm->Power level 2
User to charger distance 30 cm->Power level 3
User to charger distance 40 cm->Power level 4
User to charger distance 50 cm->Power level 5.

In the example embodiments, the source alternating current may be passed through an optional radio frequency blocking filter 110 to limit the radio frequency noise that would otherwise reach the communication circuits and RF antenna 18 of the user's communication device 200 of FIG. 2A. The optional radio frequency blocking filter 110 and the radio frequency blocking filter 210 in the user's charged device 200 of FIG. 2A are described in greater detail in the copending US patent application entitled “Wireless Charging Coil Filtering” by Esa Ilmari Saunamäki, application Ser. No. 12/498,872, filed Jul. 7, 2009, which is incorporated herein by reference.

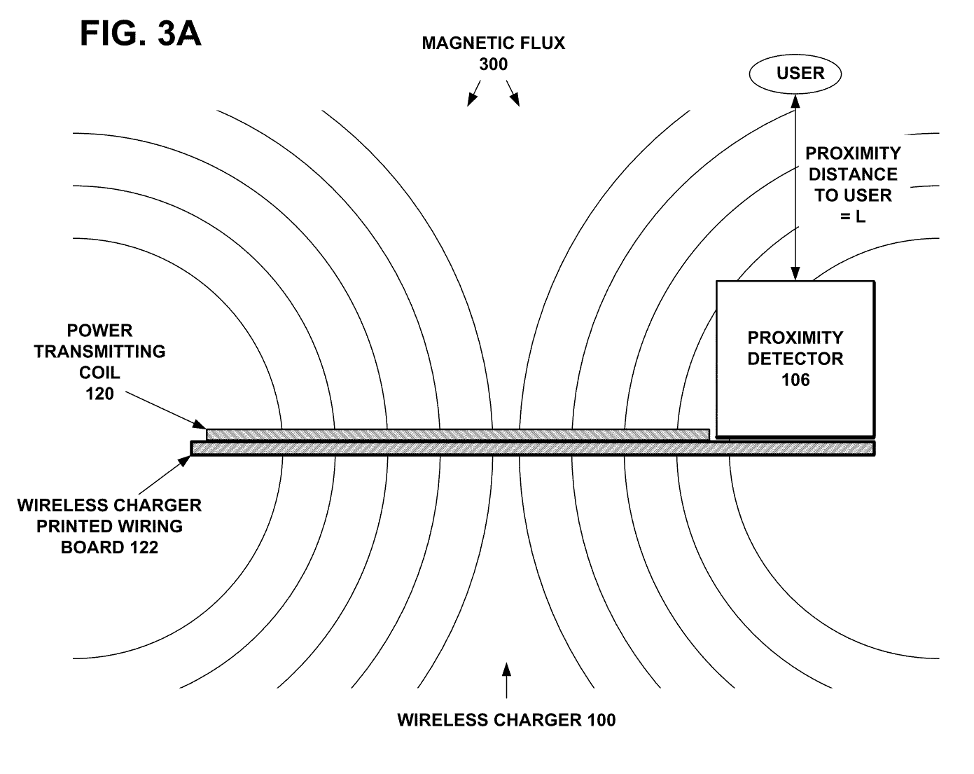

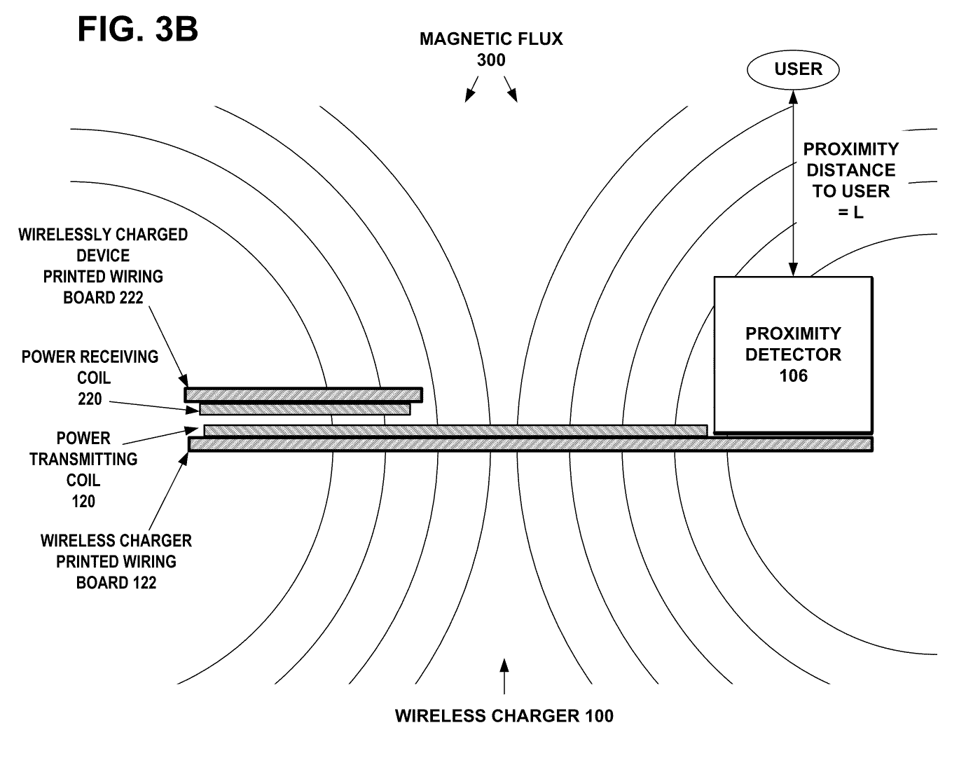

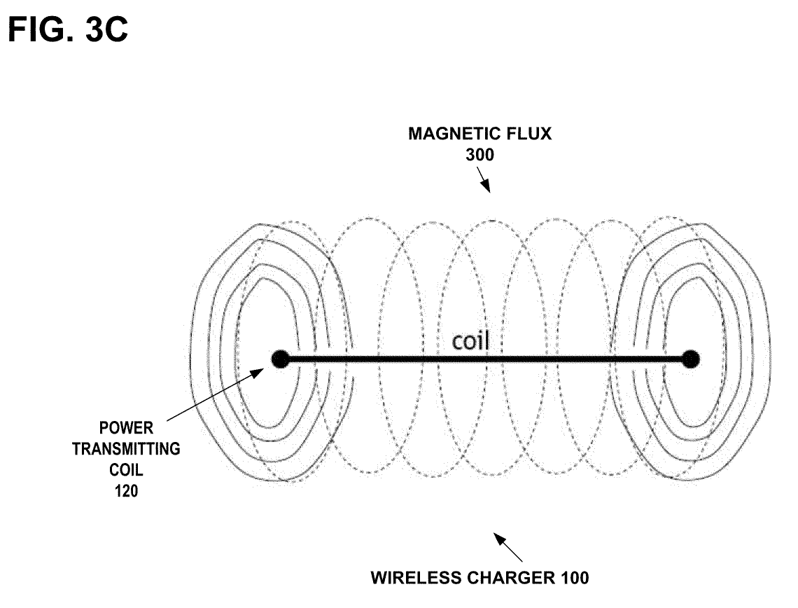

The alternating magnetic field 300 shown in FIG. 3A, which is produced by the power transmitting coil 120, magnetically couples with a proximately located receiving coil 220 in the user's charged device 200, using contact-less electromagnetic induction. The two coils 120 and 220 may be planar coils that are positioned proximate to each other in a coplanar mutual orientation, as shown in FIG. 3B, where the close proximity of the coplanar coils 120 and 220 improves the inductive coupling between them. FIG. 3C illustrates a side-view of a single turn of the power transmitting coil 120 and the resulting pattern of magnetic flux 300 encircling the single turn of the coil 120.

The user's charged device 200 may be a mobile communications device, FM radio, two-way radio, PDA, cell phone, laptop or palmtop computer, or the like. The device 200 may also be a high powered hand tool, a domestic appliance, or a garden tool using contact-less electromagnetic induction to charge its rechargeable batteries. The alternating magnetic field 300 produces a corresponding induced alternating current in the power receiving coil 220. The induced alternating current may be passed through a radio frequency blocking filter 210.

The filtered induced alternating current drives the rectifier and interface 212 in a range for example between 50 kHz and 20 MHz to produce an appropriate DC charging voltage for the rechargeable battery 216. A battery control circuit 214 adjusts the DC voltage and current. Optionally, charging identification circuits (not shown) may identify the target current and voltage to be applied to each type of rechargeable battery.

FIG. 2A shows a functional block diagram of an example embodiment of the wireless user's device 200, which is shown as a communications device, for example. The wireless device 200 may be for example a mobile communications device, FM-radio, two-way radio, PDA, cell phone, laptop or palmtop computer, or the like. The wireless device 200 includes a control module 20, which includes a central processing unit (CPU) 60, a random access memory (RAM) 62, a read only memory (ROM) 64, and interface circuits 66 to interface with the transceiver 12, battery and other energy sources, key pad, touch screen, display, microphone, speakers, ear pieces, camera or other imaging devices, etc. The RAM 62 and ROM 64 can be removable memory devices such as smart cards, SIMs, WIMs, semiconductor memories such as RAM, ROM, PROMS, flash memory devices, etc. The application and MAC layer may be embodied as program logic stored in the RAM 62 and/or ROM 64 in the form of sequences of programmed instructions which, when executed in the CPU 60, carry out the functions of the disclosed embodiments. The program logic can be delivered to the writeable RAM, PROMS, flash memory devices, etc. 62 of the wireless device 200 from a computer program product or article of manufacture in the form of computer-usable media such as resident memory devices, smart cards or other removable memory devices. Alternately, the MAC layer and application program can be embodied as integrated circuit logic in the form of programmed logic arrays or custom designed application specific integrated circuits (ASIC).

FIG. 2B illustrates an example embodiment wherein the transmitting coil 120 in the charger 100 may be part of a self-resonant circuit 125 and the receiving coil 220 in the user's device 200 may be part of a self-resonant circuit 225. The resonant circuit 125 is self-resonant at the frequency “F” and the resonant circuit 225 is self-resonant at the frequency “F”. Each resonant circuit 125 and 225 is tuned to resonate at the same frequency “F” so that they operate as magnetically coupled resonators. The transmitting coil 120 and the receiving coil 220 are strongly coupled by the resonant magnetic flux 300 oscillating at the frequency “F” when the power source circuit 102 in the charging device 100 drives the transmitting coil 120 at the resonant frequency “F” common to both coils 120 and 220. The resonant magnetic coupling is strong even when the distance between the two coils is several times larger than the geometric sizes of the coils. The resonant frequency “F” can be in the MHz range, for example from 1 MHz to over 27 MHz. This enables efficient power transfer from the wireless charger 100 to the wirelessly charged device 200.

FIG. 3A illustrates an example embodiment for a wireless charger 100 with the power transmitting coil 120 being a printed wiring coil on a printed wiring board 122 and the proximity detector 106 mounted on the board 122. The large sized wireless charger 100 has the capacity to charge rechargeable batteries in multiple portable user devices such as cell phones, high powered hand tools, domestic appliances, or garden tools using contact-less electromagnetic induction. The wireless charger 100 of FIGS. 3A and 3B is generally shaped as a flat plate and typically has an active charging surface approximately the size of a sheet of typing paper. However, the size of the charging surface may be considerably larger or smaller (than a sheet of typing paper) depending on the number and/or size of transmitting coils. The wireless charger 100 may use multiple transmitting coils 120 or a single large transmitting coil 120 to distribute its magnetic flux 300 over the active charging surface. Higher power levels greater than one watt may be required to drive the transmitting coil 120 in the wireless charger 100 in order to provide sufficient power to charge rechargeable batteries in multiple portable user devices such as cell phones or other hand tools or appliances.

FIG. 3B illustrates an example embodiment for the wireless charger 100 of FIG. 3A with the power transmitting coil 120 being a printed wiring coil on a printed wiring board 122 shown in the side view. In alternate embodiments, a separate printed wiring board 122 may be omitted and the coil 120 may incorporated into the body of the printed wiring board or it may be glued to a plastic substrate. FIG. 3B also illustrates an example embodiment for the wirelessly charged user device 200 with the power receiving coil 220 being a printed wiring coil on a printed wiring board 222 shown in the side view. In alternate embodiments, a separate printed wiring board 222 may be omitted and the coil 220 may incorporated into the body of the printed wiring board or it may be glued to a plastic substrate. Coils 120 and 220 are planar coils printed on their respective circuit boards 122 and 222. Coils 120 and 220 are shown juxtaposed, coplanar, and in close proximity to enable efficient inductive coupling by the magnetic field 300. The two coils 120 and 220 are positioned proximate to each other in a coplanar mutual orientation, so that the close proximity of the coplanar coils 120 and 220 improves the magnetic coupling between them. In embodiments, an additional ferromagnetic foil may be affixed to the backside of the coils 120 and 220 to shield any stray magnetic flux.

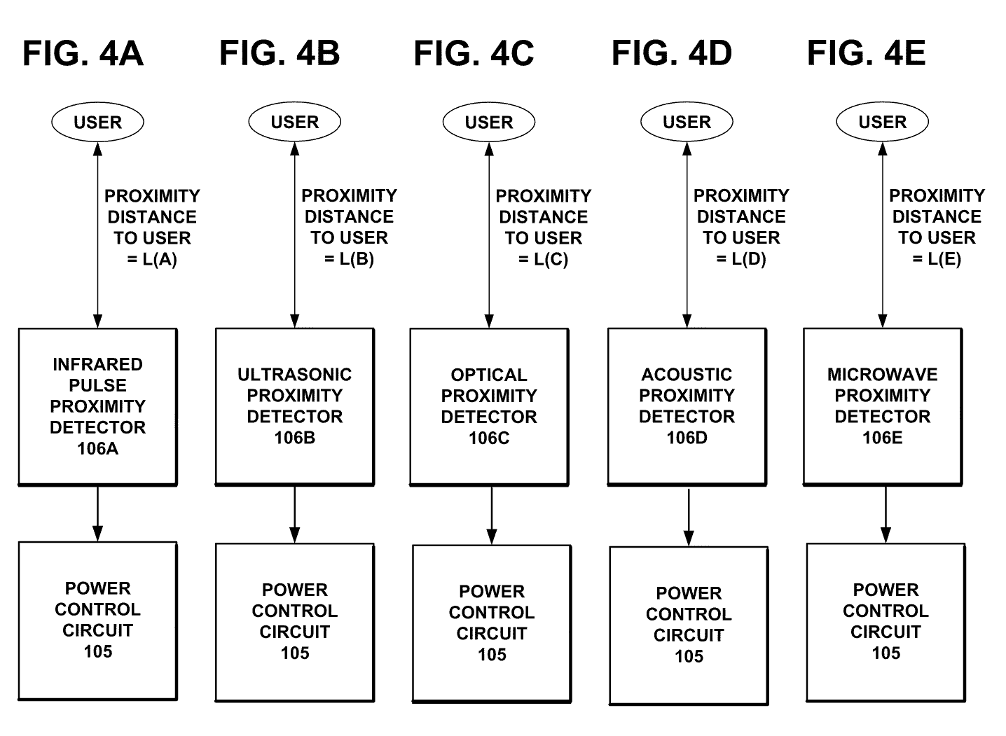

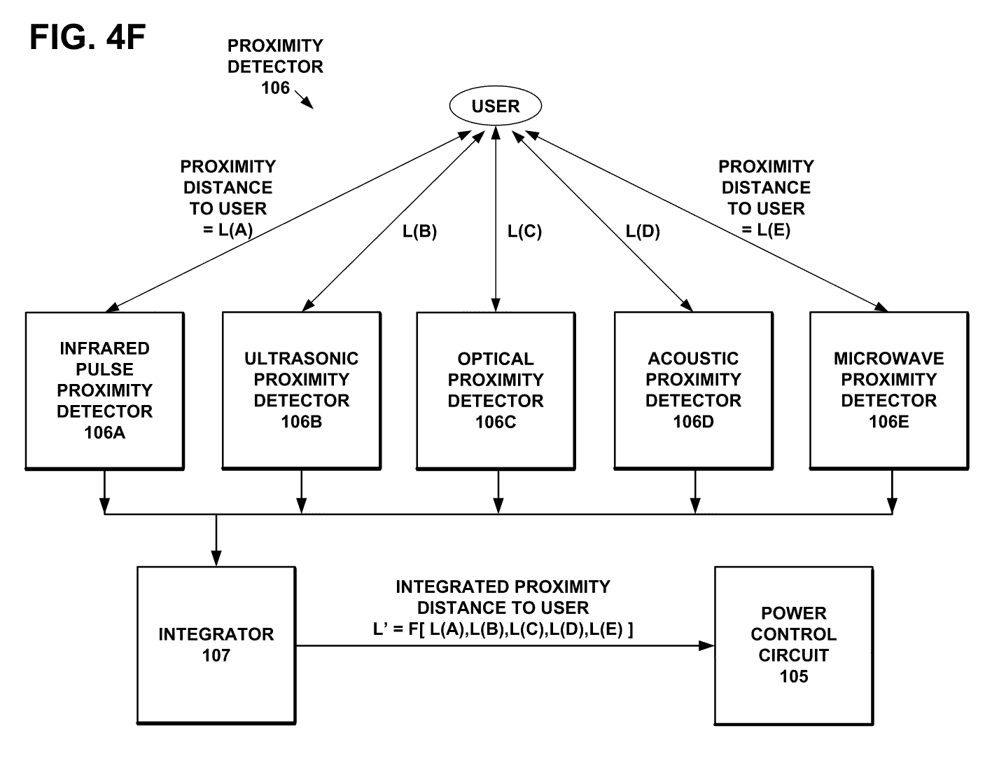

FIG. 4A illustrates an example of the infrared pulse proximity detector 106A positioned near the transmitting coil 120 on the printed wiring board 122 and coupled to the control input of the power control circuit 105, to detect proximity of the user to the detector 106A and provide a control signal to the power control circuit 105 to cause the power control circuit to reduce power delivered from the power source 102 to the transmitting coil 120. The measured proximity distance L(A) between the user and the proximity detector 106A is determined by a round trip time of flight measurement to the user.

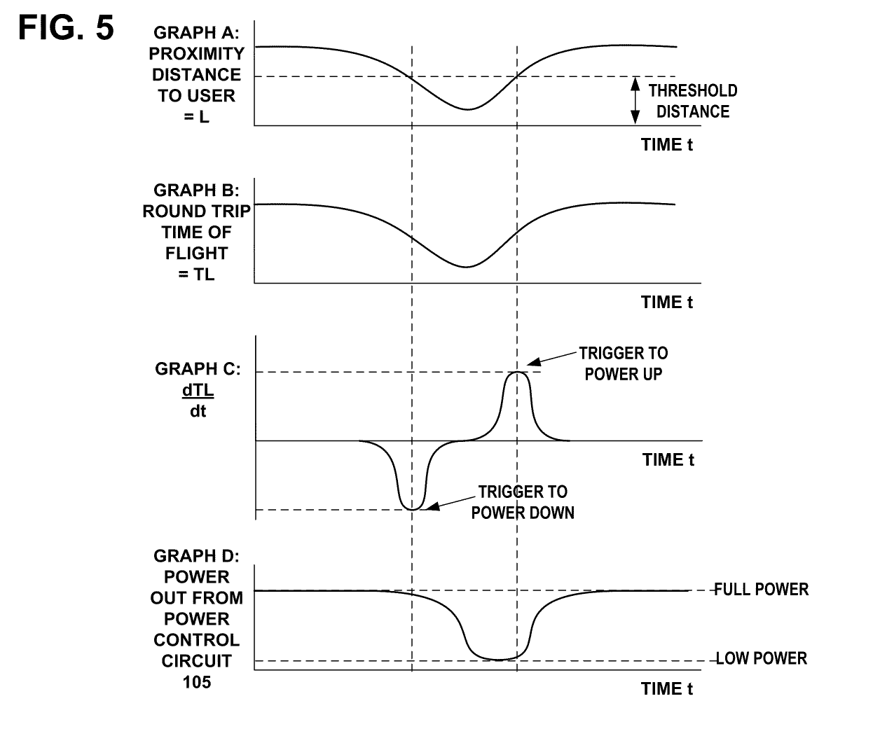

FIG. 5 is an example set of graphs in the time domain, illustrating the relationship of the measured proximity distance from the proximity detector 106 using a round trip time of flight measurement to the user, such as infrared pulse proximity detector 106A, and the resulting power output from the power control circuit 105 to the transmitting coil 120.

Graph A of FIG. 5 illustrates an example of the proximity distance “L” between the detector 106 and the user, plotted versus time. Graph B of FIG. 5 illustrates an example of the round trip time of flight “TL”, plotted versus time, for a pulse of infrared light emitted by the detector 106 and reflected back from the user to the detector 106. As the user's body approaches the detector 106, the round trip time of flight “TL” becomes smaller. In one example embodiment, the round trip time of flight “TL” may be used as a measure of the proximity of the user to the transmitting coil 120 and the proximity detector 106 will output a control signal to the power control circuit 105 when the value of “TL” indicates that the user is closer than the threshold distance.

Graph C of FIG. 5 illustrates an example of the time derivative “dTL/dt” of the round trip time of flight “TL” in Graph B, plotted versus time. The maximum negative value of the time derivative “dTL/dt” may be used as a trigger event to begin signaling the power control circuit 105 reduce the power from a full power value to a low power value for power delivered to the transmitting coil 120, in order to minimize exposure of the user to the high magnetic flux 300. Other values of the time derivative “dTL/dt” may be used as the triggering event to begin reducing power. The advantage of using the time derivative of “TL” instead of the measured round trip time of flight “TL” is that the time derivative of “TL” enables the detector 106 to distinguish a moving object, such as the user's body, from stationary objects in the vicinity of the detector 106. Graph D of FIG. 5 illustrates an example of the power output by the power control circuit 105 to the transmitting coil 120, showing that the output power begins to decrease from a full power value to a low power value for power delivered to the transmitting coil 120, when the trigger event occurs of the maximum negative value of the time derivative “dTL/dt”.

As the user's body moves away from the detector 106, the round trip time of flight “TL” becomes larger and the chance of exposure to the user is reduced. The maximum positive value of the time derivative “dTL/dt” may then be used as a trigger event, for example, to signal the power control circuit 105 to begin increasing the power to full power delivered to the transmitting coil 120. Graph D of FIG. 5 illustrates an example of the output power beginning to increase from a low power value to a full power value for power delivered to the transmitting coil 120, when the trigger event occurs of the maximum positive value of the time derivative “dTL/dt”. Other values of the time derivative “dTL/dt” may be used as the triggering event to begin increasing power.

FIG. 4B illustrates an example of the ultrasonic proximity detector 106B providing a control signal to the power control circuit 105 to cause the power control circuit to reduce power delivered from the power source 102 to the transmitting coil 120. The relationship of the measured proximity distance L(B) from the proximity detector 106B using a round trip time of flight measurement to the user and the resulting power output from the power control circuit 105 to the transmitting coil 120, is similar to that described in FIG. 5.

FIG. 4C illustrates an example of the optical proximity detector 106C providing a control signal to the power control circuit 105 to cause the power control circuit to reduce power delivered from the power source 102 to the transmitting coil 120. The relationship of the measured proximity distance L(C) from the proximity detector 106C using a round trip time of flight measurement to the user and the resulting power output from the power control circuit 105 to the transmitting coil 120, is similar to that described in FIG. 5.

FIG. 4D illustrates an example of the acoustic proximity detector 106D providing a control signal to the power control circuit 105 to cause the power control circuit to reduce power delivered from the power source 102 to the transmitting coil 120. The relationship of the measured proximity distance L(D) from the proximity detector 106D using a round trip time of flight measurement to the user and the resulting power output from the power control circuit 105 to the transmitting coil 120, is similar to that described in FIG. 5.

FIG. 4E illustrates an example of the microwave proximity detector 106E providing a control signal to the power control circuit 105 to cause the power control circuit to reduce power delivered from the power source 102 to the transmitting coil 120. The relationship of the measured proximity distance L(E) from the proximity detector 106E using a round trip time of flight measurement to the user and the resulting power output from the power control circuit 105 to the transmitting coil 120, is similar to that described in FIG. 5.

FIG. 4F illustrates an example of the proximity detector 106 being a combination of an infrared detector 106A, an ultrasonic detector 106B, an optical detector 106C, an acoustic detector 106D, and a microwave detector 106E. The output of these detectors is integrated in the integrator 107 to obtain an aggregate proximity distance value L′ using an empirical relationship=F[L(A),L(B),L(C),L(D),L(E)]. The output L′ of the integrator 107 is applied to the control input of the power control circuit 105 to cause the power control circuit 105 to reduce power delivered from the power source 102 to the transmitting coil 120.

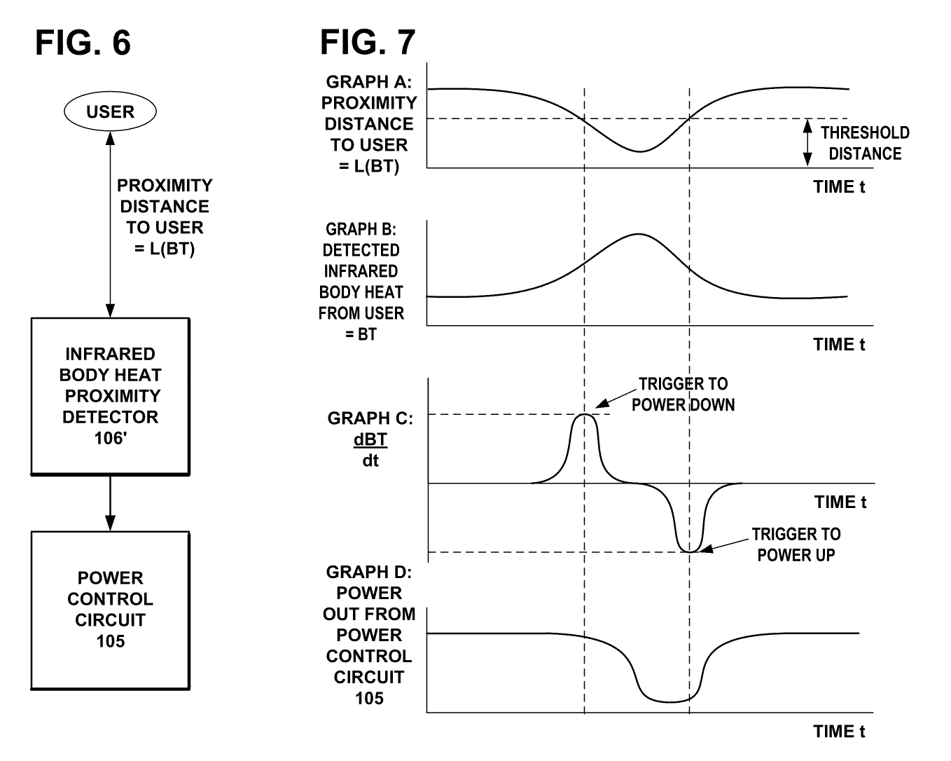

FIG. 6 illustrates an example of the infrared body heat proximity detector 106′ providing a control signal to the power control circuit 105 to cause the power control circuit to reduce power delivered from the power source 102 to the transmitting coil 120. FIG. 7 is an example set of graphs in the time domain, illustrating the relationship of the measured proximity distance L(BT) from the proximity detector 106′ using the user's measured infrared body heat and the resulting power output from the power control circuit 105 to the transmitting coil 120.

Graph A of FIG. 7 illustrates an example of the proximity distance “L” between the detector 106 and the user, plotted versus time. Graph B of FIG. 7 illustrates an example of the user's measured infrared body heat “BT”, plotted versus time. As the user's body approaches the detector 106, user's measured infrared body heat becomes larger. In one example embodiment, the user's measured infrared body heat “BT” may be used as a measure of the proximity of the user to the transmitting coil 120 and the proximity detector 106 will output a control signal to the power control circuit 105 when the value of “BT” indicates that the user is closer than the threshold distance.

Graph C of FIG. 7 illustrates an example of the time derivative “dBT/dt” of the user's measured infrared body heat in Graph B, plotted versus time. The maximum positive value of the time derivative “dBT/dt” may be used as a trigger event to begin signaling the power control circuit 105 reduce the power from a full power value to a low power value for power delivered to the transmitting coil 120, in order to minimize exposure of the user to the high magnetic flux 300. Other values of the time derivative “dBT/dt” may be used as the triggering event to begin reducing power. The advantage of using the time derivative of “BT” instead of the user's measured infrared body heat “BT” is that the time derivative of “BT” enables the detector 106′ to distinguish a moving object, such as the user's body, from stationary objects in the vicinity of the detector 106. Graph D of FIG. 7 illustrates an example of the power output by the power control circuit 105 to the transmitting coil 120, showing that the output power begins to decrease from a full power value to a low power value for power delivered to the transmitting coil 120, when the trigger event occurs of the maximum positive value of the time derivative “dBT/dt”.

As the user's body moves away from the detector 106′, the user's measured infrared body heat “BT” becomes smaller and the chance of exposure to the user is reduced. The maximum negative value of the time derivative “dBT/dt” may then be used as a trigger event, for example, to signal the power control circuit 105 to begin increasing the power to full power delivered to the transmitting coil 120. Graph D of FIG. 7 illustrates an example of the output power beginning to increase from a low power value to a full power value for power delivered to the transmitting coil 120, when the trigger event occurs of the maximum negative value of the time derivative “dBT/dt”. Other values of the time derivative “dBT/dt” may be used as the triggering event to begin increasing power.

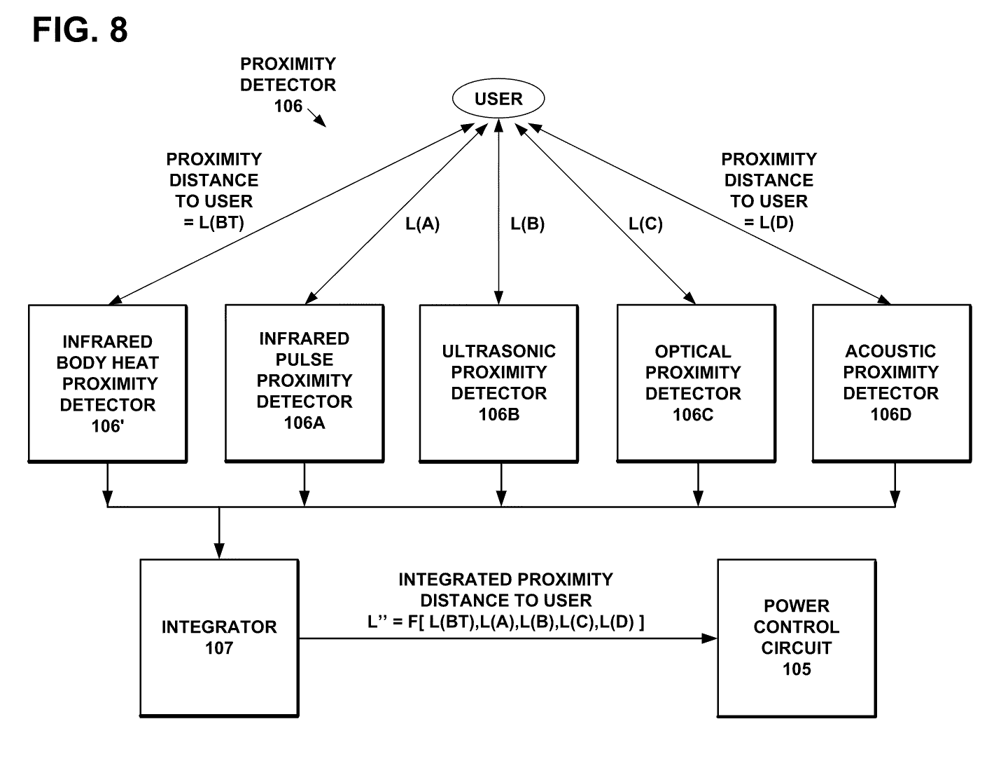

FIG. 8 illustrates an example of the proximity detector being a combination of the infrared user's body heat proximity detector 106′ of FIG. 6, an infrared pulse proximity detector 106A of FIG. 4A, an ultrasonic detector 106B, an optical detector 106C, and an acoustic detector 106D. The output of these detectors is integrated in the integrator 107 to obtain an aggregate proximity distance value L″ using an empirical relationship=F[L(BT),L(A),L(B),L(C),L(D)]. The output L″ of the integrator 107 is applied to the control input of the power control circuit 105 to cause the power control circuit 105 to reduce power delivered from the power source 102 to the transmitting coil 120. Any combination of detectors shown in FIGS. 8 and 4F can be used (e.g. 106A+106C+106E). Another type of proximity detector is a camera based sensor programmed with software for movement detection.

An optional light, buzzer, or other indictor may be coupled to the power control circuit 105 to alert the user when power has been reduced to the transmitting coil 120 because the user has moved closer than a safe distance from the transmitting coil during the charging operation.

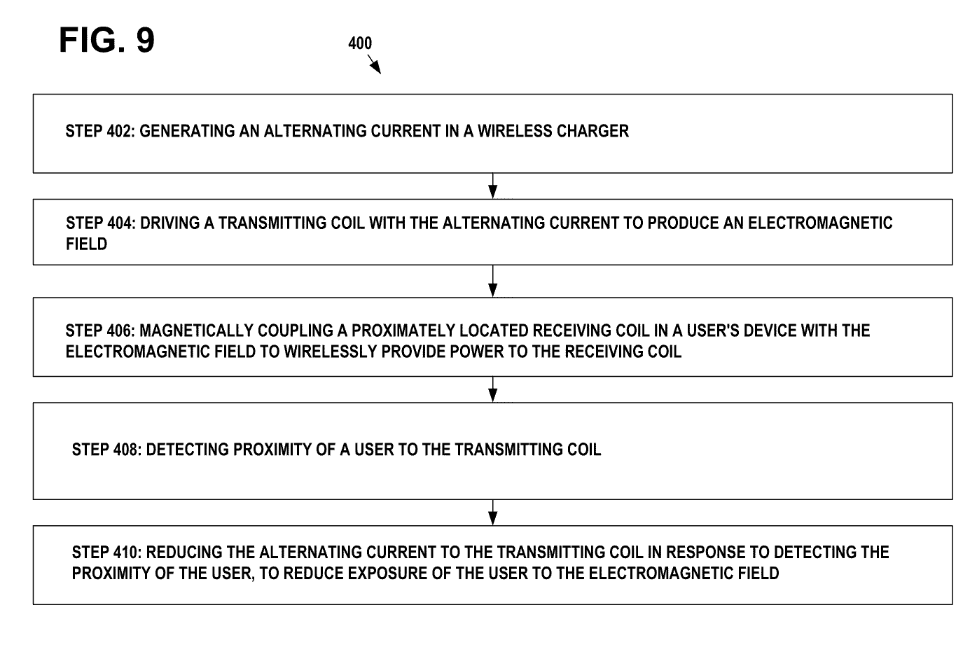

The method 400 of FIG. 9 includes the following steps:

Step 402: Generate with power source 102 an alternating current in a wireless charger 100.

Step 404: Drive a transmitting coil 120 with the alternating current to produce an electromagnetic field 300.

Step 406: Magnetically couple a proximately located receiving coil 220 in a user's device 200 with the electromagnetic field 300 to wirelessly provide power to the receiving coil 220.

Step 408: Detect proximity with proximity detector 106 of a user to the transmitting coil 120.

Step 410: Reduce with power control circuit 105 the alternating current to the transmitting coil 120 in response to detecting the proximity of the user, to reduce exposure of the user to the electromagnetic field 300.

In this manner, the exposure of the user is minimized near the active charging surface of the wireless charger 100, to the intense electromagnetic fields. The detector(s) can also detect the proximity of pets or domestic animals, in addition to a human user.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention.

What is claimed is:

1. An apparatus, comprising:
a power source circuit in a wireless charging device configured to produce a source alternating current;
a transmitting coil configured to magnetically couple with a proximately located receiving coil in a user's device, to wirelessly provide power to the receiving coil;
a power control circuit coupled between the power source and the transmitting coil, having a control input configured to control power delivered from the power source to the transmitting coil; and
a proximity detector positioned near the transmitting coil and coupled to the control input of the power control circuit, to detect proximity of the user to the detector and provide a control signal to the power control circuit to cause the power control circuit to reduce power delivered from the power source to the transmitting coil.

2. The apparatus of claim 1, which further comprises:
the proximity detector being an infrared detector configured to detect a threshold level of body heat radiating from the user and to cause the power control circuit to reduce power delivered from the power source to the transmitting coil.

3. The apparatus of claim 1, which further comprises:
the proximity detector being an ultrasonic detector configured to transmit a primary ultrasound signal and to detect a threshold level of reflected ultrasound signal from the user and to cause the power control circuit to reduce power delivered from the power source to the transmitting coil.

4. The apparatus of claim 1, which further comprises:
the proximity detector being an optical detector configured to transmit a primary light signal and to detect a threshold level of reflected light signal from the user and to cause the power control circuit to reduce power delivered from the power source to the transmitting coil.

5. The apparatus of claim 1, which further comprises:
the proximity detector being an acoustic detector configured to transmit a primary acoustic signal and to detect a threshold level of reflected acoustic signal from the user and to cause the power control circuit to reduce power delivered from the power source to the transmitting coil.

6. The apparatus of claim 1, which further comprises:
the proximity detector being a microwave detector configured to transmit a primary microwave signal and to detect a threshold level of reflected microwave signal from the user and to cause the power control circuit to reduce power delivered from the power source to the transmitting coil.

7. The apparatus of claim 1, which further comprises:
the proximity detector being an infrared pulse detector configured to transmit a primary infrared pulse signal and to detect a threshold level of reflected infrared pulse signal from the user and to cause the power control circuit to reduce power delivered from the power source to the transmitting coil.

8. The apparatus of claim 1, which further comprises:
the proximity detector being a combination of two or more detectors taken from the group consisting of an infrared detector, an ultrasonic detector, an optical detector, an acoustic detector, and a microwave detector, the combination of detectors configured to detect proximity of the user and to cause the power control circuit to reduce power delivered from the power source to the transmitting coil.

9. The apparatus of claim 1, which further comprises:
the detector and the transmitting coil being configured to be positioned in close proximity to one another on a substrate.

10. The apparatus of claim 1, which further comprises:
the power control circuit configured to reduce power to the transmitting coil upon receiving the control signal from the detector, so as to reduce ambient electromagnetic fields near the transmitting coil to a safe exposure level for the user.

11. The apparatus of claim 1, which further comprises:
the transmitting coil being configured to wirelessly charge rechargeable batteries in multiple portable communication devices, high powered hand tools, domestic appliances, or garden tools.

12. A method, comprising:
generating an alternating current in a wireless charger;
driving a transmitting coil with the alternating current to produce an electromagnetic field;
magnetically coupling a proximately located receiving coil in a user's device with the electromagnetic field to wirelessly provide power to the receiving coil;
detecting proximity of a user to the transmitting coil; and
reducing the alternating current to the transmitting coil in response to detecting the proximity of the user, to reduce exposure of the user to the electromagnetic field.

13. The method of claim 12, which further comprises:
the detecting being with an infrared detector configured to detect a threshold level of body heat radiating from the user and to cause a reduction in power delivered from a power source to the transmitting coil.

14. The method of claim 12, which further comprises:
the detecting being with an ultrasonic detector configured to transmit a primary ultrasound signal and to detect a threshold level of reflected ultrasound signal from the user and to cause a reduction in power delivered from a power source to the transmitting coil.

15. The method of claim 12, which further comprises:
the detecting being with an optical detector configured to transmit a primary light signal and to detect a threshold level of reflected light signal from the user and to cause a reduction in power delivered from a power source to the transmitting coil.

16. The method of claim 12, which further comprises:
the detecting being with an acoustic detector configured to transmit a primary acoustic signal and to detect a threshold level of reflected acoustic signal from the user and to cause a reduction in power delivered from a power source to the transmitting coil.

17. The method of claim 12, which further comprises:
the detecting being with a microwave detector configured to transmit a primary microwave signal and to detect a threshold level of reflected microwave signal from the user and to cause a reduction in power delivered from a power source to the transmitting coil.

18. The method of claim 12, which further comprises:
the detecting being with an infrared pulse detector configured to transmit a primary infrared pulse signal and to detect a threshold level of reflected infrared pulse signal from the user and to cause a reduction in power delivered from a power source to the transmitting coil.

19. The method of claim 12, which further comprises:
the detecting being with a combination of two or more detectors taken from the group consisting of an infrared detector, an ultrasonic detector, an optical detector, an acoustic detector, and a microwave detector, the combination of detectors configured to detect proximity of the user and to cause a reduction in power delivered from a power source to the transmitting coil.

20. The method of claim 12, which further comprises:
reducing power to the transmitting coil upon the detecting, so as to reduce ambient electromagnetic fields near the transmitting coil to a safe exposure level for the user.

21. The method of claim 12, wherein said magnetic coupling is inductive coupling using contact-less electromagnetic induction, to wirelessly provide power to the receiving coil.

22. The method of claim 12, wherein said magnetic coupling is resonant magnetic coupling, to wirelessly provide power to the receiving coil.

23. The method of claim 12, wherein said reducing the alternating current is performed in graduated steps based on said detecting proximity of the user to the transmitting coil.

24. The apparatus of claim 1, wherein said magnetic coupling is inductive coupling using contact-less electromagnetic induction, to wirelessly provide power to the receiving coil.

25. The apparatus of claim 1, wherein said magnetic coupling is resonant magnetic coupling, to wirelessly provide power to the receiving coil.

26. The apparatus of claim 1, wherein said reduction in power delivered from the power source to the transmitting coil is performed in graduated steps based on said detected proximity of the user to the transmitting coil.
